(19) United States
(12) Patent Application Publication
(10) Pub. No.: US 2010/0188811 A1
(43) Pub. Date: Jul. 29, 2010

(54) Memory cooling device

(75) Inventor: Chien-Kuo Liang, Chung-Ho City (TW)

Correspondence Address: Jackson Intellectual Property Group PLLC, 106 Starvale Lane, Shipman, VA, 22971, US

(73) Assignee: Aeon Lighting Technology Inc.

(21) Appl. No.: 11/822,422

(22) Filed: Jul. 5, 2007

(51) Int. Cl. G06F 1/20

(52) U.S. Cl. 361/679.52

(57) ABSTRACT

A memory cooling device includes a left clamping seat and a right clamping seat that clamp at least one heat pipe. At least one side of the heat pipe is a straight surface which is affixed with a clamping surface of the left clamping seat or the right clamping seat through a thermal adhesive, and another surface of the thermal adhesive is affixed on a bottom surface of the memory, such that operating temperature generated by the working memory can be directly transmitted to the heat pipe and the left and right clamping seats through the thermal adhesive, to increase the heat dissipation efficiency for the memory, and actually and effectively dissipate the heat, thereby improving a lifetime of usage of the memory.

### BACKGROUND OF THE INVENTION

a) Field of the Invention

The present invention relates to a memory cooling device, and more particularly to a cooling device which is able to improve a heat dissipation efficiency of a memory or a chip, thereby increasing a lifetime of usage for the memory or chip.

b) Description of the Prior Art

A conventional heat dissipation structure for a memory is disclosed in the Taiwanese Utility Model Patent No. M298165, wherein connection sections of a heat pipe are inserted into arc-shape grooves of a connection seat, and a cross-over member is used to clamp a memory. However, under a long term usage, the structure is provided with following shortcomings:
(1) As shown in FIG. 2 and FIG. 4 of the prior art, when the memory generates heat, the heat is first transmitted to the aluminum-extrusion connection seat, and is then transmitted to the heat pipes from the arc-shape grooves of the connection seat. Therefore, the heat is indirectly transmitted from the heat pipes to result in an inferior heat transmission effect, thereby prohibiting the heat of the working memory from being transmitted and dissipated efficiently and quickly.
(2) Inner walls of the cross-over member directly clamp the memory, and surfaces where the two elements are fitted are provided with gaps, rough surfaces, or capillaries, which will induce an inferior heat dissipation effect.

### SUMMARY OF THE INVENTION

The primary object of the present invention is to provide a memory cooling device such that by a straight surface at a side of a heat pipe, and by affixing at least one layer of thermal adhesive on a surface of a memory, operating temperature of a working memory can be transmitted directly to the heat pipe and a left and a right clamping seat by the thermal adhesive, to provide a higher heat dissipation rate of the memory and more actual and efficient heat dissipation, thereby improving a lifetime of usage for the memory.

Another object of the present invention is to provide a memory cooling device such that by using the thermal adhesive as a connection interface between an outer wall of the heat pipe and the memory, the heat dissipation effect of the memory can be further improved.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of parts of the present invention.

FIG. 2 shows a front view of the present invention.

FIG. 3 shows a cross-sectional view along a line I-I of FIG. 2.

FIG. 4 shows an exploded view of another embodiment of the present invention.

FIG. 5 shows a front view of another embodiment of the present invention.

FIG. 6 shows a cross-sectional view along a line II-II of FIG. 5.

### DETAILED DESCRIPTION OF THE PREFERRED EMBODIMENTS

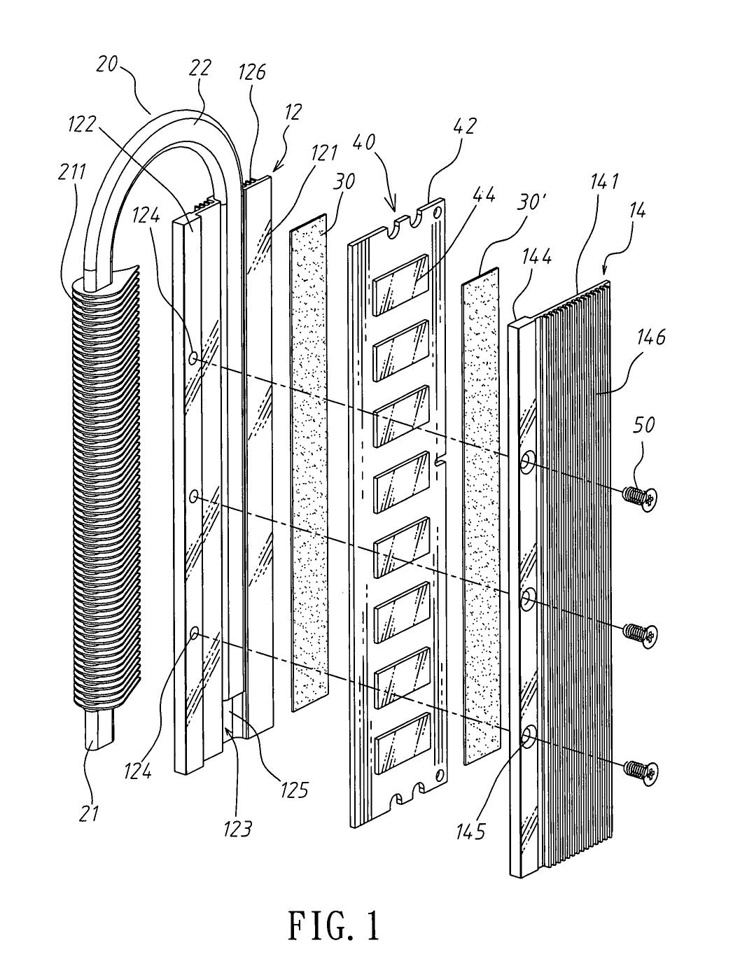

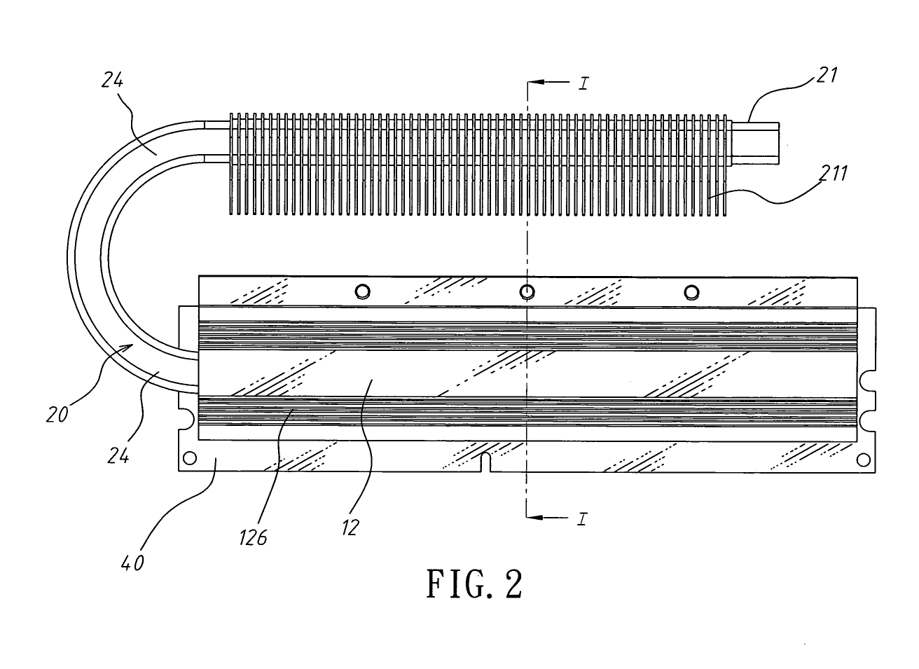

Referring to FIGS. 1 to 3, the present invention is to provide a memory cooling device, including a left clamping seat 12 which is provided with a lower clamping surface 121 and a higher fixing interface 122, with the clamping surface 121 being provided with a groove 123; a first heat pipe 20, at least one side of which is formed with a first straight surface 22, and which is latched into the groove 123, with a first thermal adhesive 30 being affixed on the clamping surface 121 and the first straight surface 22; a memory 40, a bottom surface 42 of which is affixed on a surface of the first thermal adhesive 30; a second thermal adhesive 30′ which is affixed on an outer surface 44 of the memory 40; a right clamping seat 14 which is provided with a lower clamping surface 141 and a higher fixing interface 144, with the clamping surface 141 being affixed on an outer surface of the second thermal adhesive 30′, the fixing interface 144 being connected and fixed with the fixing interface 122 of the left clamping seat 12, and the left and right clamping seats 12, 14 clamping and affixing the memory 40 and the first heat pipe 20, respectively. Operating temperature generated by the memory 40 is transmitted to the first thermal adhesive 30 from the bottom surface 42, and is then directly transmitted to the first straight surface 22 of the first heat pipe 20; whereas, the operating temperature generated by the memory 40 is transmitted to the second thermal adhesive 30′ from the outer surface 44, and is then transmitted to the clamping surface 141 of the right clamping seat 14 for cooling.

The first thermal adhesive 30 can be coated in a glue shape on the clamping surface 121 of the left clamping seat 12, and the first straight surface 22, allowing the bottom surface 42 of the memory 40 to be affixed into the first thermal adhesive 30.

The second thermal adhesive 30′ can be coated in a glue shape on the clamping surface 141 of the right clamping seat 14, allowing the outer surface 44 of the memory 40 to be affixed into the second thermal adhesive 30′.

The fixing interface 122 of the left clamping seat 12 is provided with connection holes 124, the fixing interface 144 of the right clamping seat 14 is provided with connection holes 145, and bolts 50 are screwed into the connection holes 145, 124, to connect the left and right clamping seats 12, 14 into one body.

Heat generated from the bottom surface 42 of the memory 40 can be transmitted to the clamping surface 121 of the left clamping seat 12 through the first thermal adhesive 30.

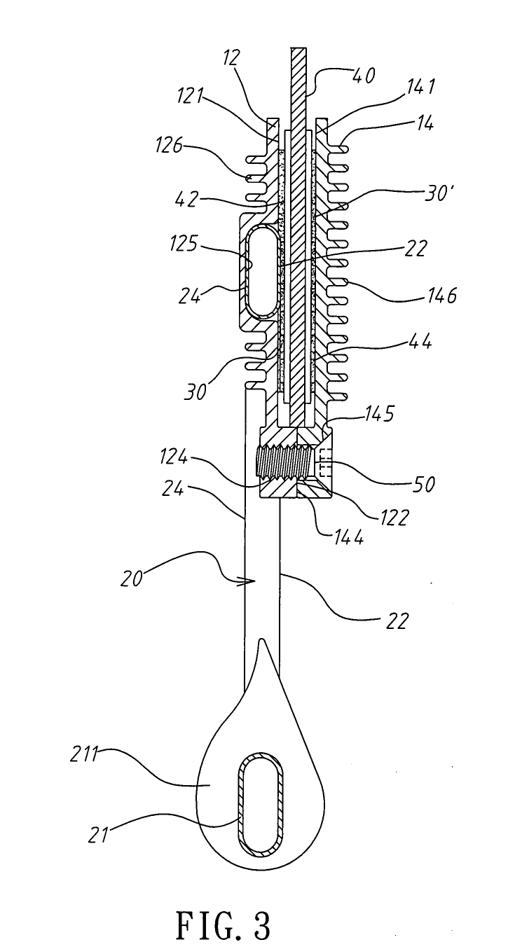

The first heat pipe 20 is provided with a second straight surface 24 at a location opposite to the first straight surface 22, and the second straight surface 24 is latched to and in touch with a groove wall 125 (as shown in FIG. 3) of the groove 123.

The first heat pipe 20 is in a U shape and is disposed with an outer pipe 21. A surface of the outer pipe 21 is latched with cooling fins 211 (as shown in FIG. 1).

Outer surfaces of the left and right clamping seats 12, 14 are provided with cooling gills 126, 146.

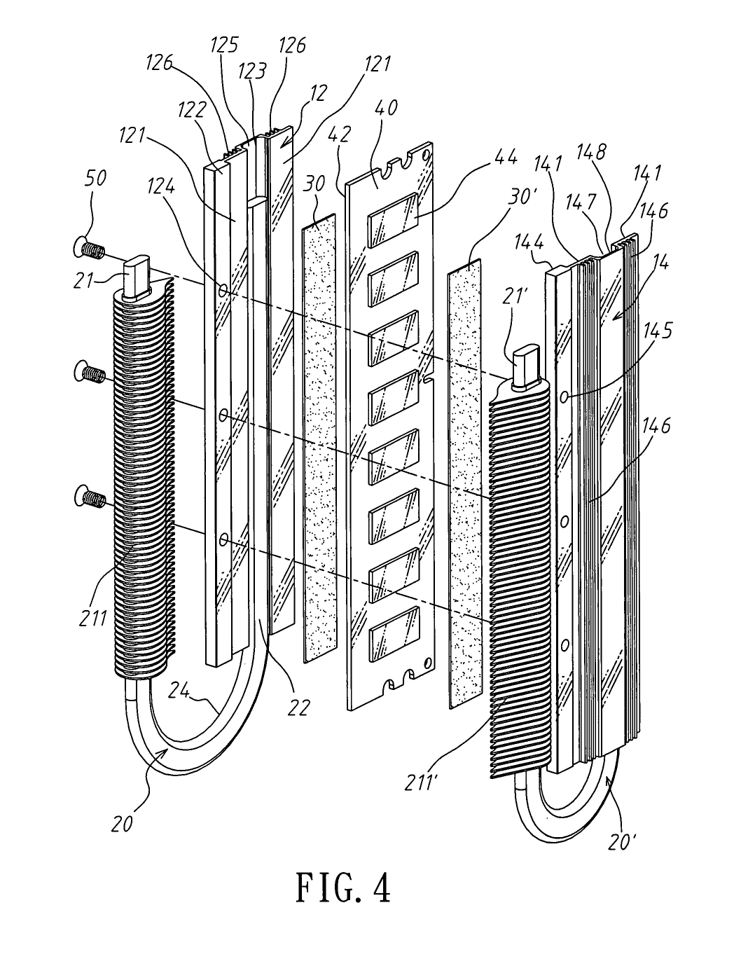

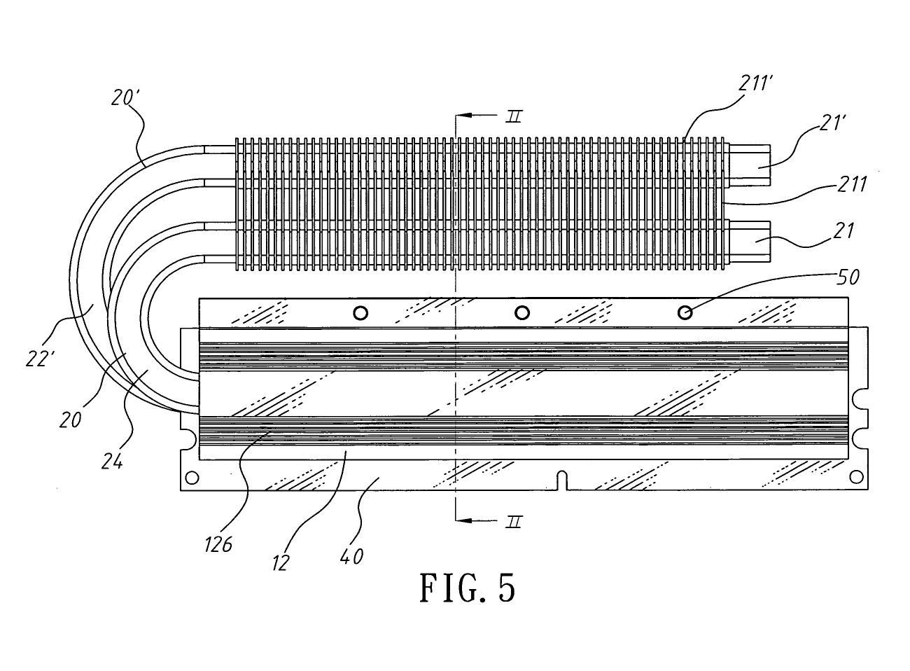

Referring to FIGS. 4 to 6, the present invention is to provide a memory cooling device, including a left clamping seat 12 which is provided with a lower clamping surface 121 and a higher fixing interface 122, with the clamping surface 121 being disposed with a groove 123; a first heat pipe 20, at least one side of which is formed with a first straight surface 22, and which is latched into the groove 123, with a first thermal adhesive 30 being affixed on the clamping surface 121 and the first straight surface 22; a memory 40, a bottom surface 42 of which is affixed on a surface of the first thermal adhesive 30; a second thermal adhesive 30′ which is affixed on an outer surface 44 of the memory 40; a right clamping seat 14 which is provided with a lower clamping surface 141 and a higher fixing interface 144, with the clamping surface 141 being disposed with a groove 147; and a second heat pipe 20′, at least one side of which is formed with a first straight surface 22′, and which is latched into the groove 147, with the second thermal adhesive 30′ being affixed on the clamping surface 141 and the first straight surface 22′.

The outer surface 44 of the memory 40 is affixed on a surface of the second thermal adhesive 30′, the fixing interface 144 of the right clamping seat 14 is connected and fixed with the fixing interface 122 of the left clamping seat 12, and the left and right clamping seats 12, 14 clamp and affix the memory 40 and the first and second heat pipes 20, 20′ respectively. Operating temperature generated by the memory 40 is transmitted to the first thermal adhesive 30 from the bottom surface 42, and is then directly transmitted to the first straight surface 22 of the first heat pipe 20; whereas, the operating temperature generated by the memory 40 is transmitted to the second thermal adhesive 30′ from the outer surface 44, and is directly transmitted to the first straight surface 22′ of the second heat pipe 20′ for cooling.

The first thermal adhesive 30 can be coated in a glue shape on the clamping surface 121 of the left clamping seat 12, and the first straight surface 22, allowing the bottom surface 42 of the memory 40 to be affixed into the first thermal adhesive 30.

The second thermal adhesive 30′ can be coated in a glue shape on the clamping surface 141 of the right claming seat 14, allowing the outer surface 44 of the memory 40 to be affixed into the second thermal adhesive 30′.

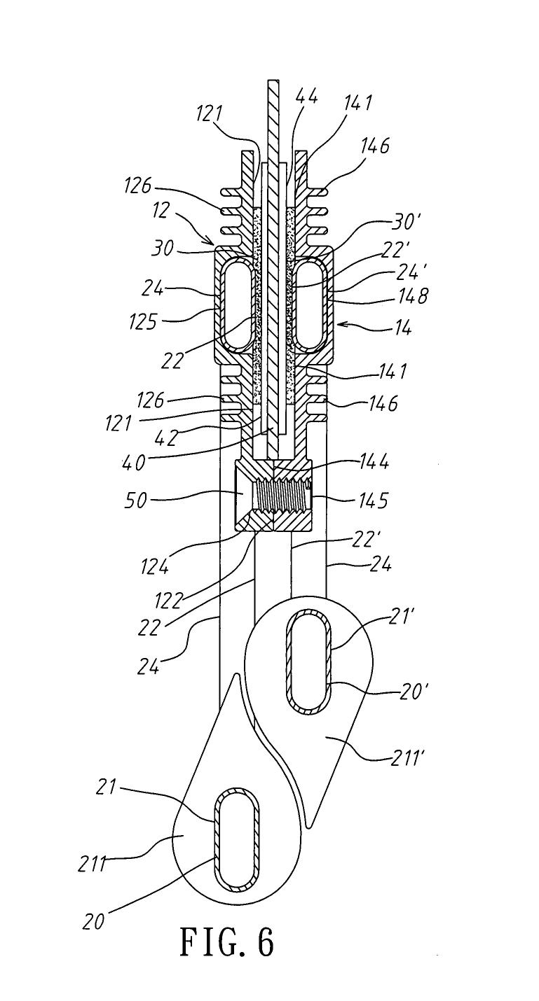

Referring to FIG. 6, the first and second heat pipes 20, 20′ are provided with second straight surfaces 24, 24′ at locations opposite to the first straight surfaces 22, 22′. The two second straight surfaces 24, 24′ are latched into and in touch with groove walls 125, 148 of the two grooves 123, 147 respectively.

The fixing interface 122 of the left clamping seat 12 is provided with connection holes 124, the fixing interface 144 of the right clamping seat 14 is provided with connection holes 145, and bolts 50 are screwed into the connection holes 145, 124, to connect the left and right clamping seats 12, 14 into one body.

Temperature generated from the bottom surface 42 of the memory 40 can be transmitted to the clamping surface 121 of the left clamping seat 12 through the first thermal adhesive 30; whereas, temperature generated from the outer surface 44 of the memory 40 can be transmitted to the clamping surface 141 of the right clamping seat 14 through the second thermal adhesive 30′.

Referring to FIGS. 1 to 3, the left and right clamping seats 12, 14 of the present invention clamp the single first heat pipe 20. In other words, temperature of the bottom surface 42 of the memory 40 is transmitted to the first heat pipe 20 and the left clamping seat 12 for cooling, through the first thermal adhesive 30. As the first straight surface 22 is a horizontal and straight surface, and the first thermal adhesive 30 is plastic, the first thermal adhesive 30 can be uniformly affixed on the first straight surface 22 and the clamping surface 121. In addition, the first thermal adhesive 30 can be also uniformly affixed on the bottom surface 42 of the memory 40, due to its plasticity. Therefore, when the memory 40 generates heat from operating, its temperature can be uniformly transmitted to the first thermal adhesive 30, and then transmitted to the first straight surface 22 and the clamping surface 121 from the first thermal adhesive 30, enabling temperature generated from the bottom surface 42 of the memory 40 to be cooled down through the left clamping seat 12 and the first heat pipe 20. The outer surface 44 of the memory 40 and the plastic second thermal adhesive 30′ are affixed uniformly, and the second thermal adhesive 30′ and the clamping surface 141 are affixed uniformly, enabling heat generated from the outer surface 44 to be transmitted to the right clamping seat 14 through the second thermal adhesive 30′.

The first straight surface 22 of the first heat pipe 20 is affixed on the bottom surface 42 by the first thermal adhesive 30. As a design of the first straight surface 22, heat conduction area is enlarged. Due to that the first thermal adhesive 30 is plastically (can be filled) affixed to surface capillaries of the first straight surface 22, surface capillaries of the clamping surface 121, and capillaries of the bottom surface 42, an efficiency of transmitting heat from the bottom surface 42 to the first straight surface 22 is completely improved, thereby increasing the heat dissipation efficiency.

The second thermal adhesive 30′ is plastically (can be filled) affixed on surface capillaries of the clamping surface 141, and is plastically affixed on the outer surface 44, enabling heat on the outer surface 44 to be efficiently transmitted to the right clamping seat 14 for cooling. Its heat dissipation efficiency is apparently improved from the affixing of the second thermal adhesive 30′. Furthermore, fins 211 are used to enhance the effect of heat dissipation for the first heat pipe 20, and the gills 126, 146 also improve the effect of heat dissipation.

Referring to FIGS. 4 to 6, the left and right clamping seats 12, 14 of the present invention clamp the first and second heat pipes 20, 20′. In other words, for the single memory 40 with higher operating temperature, heat can be directly dissipated through the two heat pipes 20, 20′ respectively, to improve the heat dissipation efficiency. The groove 147 of the right clamping seat 14 is latched with the second heat pipe 20′, and then by affixing the second thermal adhesive 30′ on the outer surface 44 of the memory 40, and the first straight surface 22′ of the second heat pipe 20′, the bottom surface 42 and the outer surface 44 of the memory 40 can be further used as intermediate heat transmission media to improve the heat transmission efficiency for the first and second heat pipes 20, 20′, through the first and second thermal adhesives 30, 30′ respectively.

Furthermore, the first and second heat pipes 20, 20′ are latched respectively into the grooves 123, 147, and also transmit the heat to the left and right clamping seats 12, 14 for cooling, upon transmitting the heat. In a same time, fins 211′ that are fixed on an outer pipe 21′ also enhance the effect of heat dissipation for the second heat pipe 20′, and the gill 146 is also used to enhance the effect of heat dissipation.

Accordingly, as the first and second heat pipes 20, 20′ of the present invention are provided with the first straight surfaces 22, 22′ of larger areas, which provide larger heat conduction areas; and the heat transmission is executed using the first and second thermal adhesives 30, 30′ as the heat transmission media, the heat transmission efficiency will be improved. Therefore, operating temperature on the bottom surface 42 and the outer surface 44 of the memory 40 can be almost directly transmitted to the first and second heat pipes 20, 20′, which is provided with the heat dissipation efficiency higher than that of the prior art, thereby effectively solving the problems that the heat is insufficiently dissipated from the memory 40, and that the heat dissipation efficiency is inferior.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A memory cooling device comprising:
a left clamping seat which is provided with a lower clamping surface and a higher fixing interface, with the clamping surface being disposed with a groove; a first heat pipe, at least one side of which is formed with a first straight surface, and which is latched into the groove, with a first thermal adhesive being affixed on the clamping surface and the first straight surface; a memory, a bottom surface of which is affixed on a surface of the first thermal adhesive; a second thermal adhesive which is affixed on an outer surface of the memory; and a right clamping seat which is provided with a lower clamping surface and a higher fixing interface, with the clamping surface being affixed on an outer surface of the second thermal adhesive, the fixing interface being connected and fixed with the fixing interface of the left clamping seat, and the left and right clamping seats clamping and affixing the memory and the first heat pipe respectively; operating temperature generated by the memory being transmitted to the first thermal adhesive from the bottom surface, and then being directly transmitted to the first straight surface of the first heat pipe, whereas the operating temperature generated by the memory being transmitted to the second thermal adhesive from the outer surface, and being directly transmitted to the clamping surface of the right clamping seat for cooling.

2. The memory cooling device according to claim 1, wherein the first thermal adhesive is coated in a glue shape on the clamping surface of the left clamping seat, and the first straight surface, allowing the bottom surface of the memory to be affixed into the first thermal adhesive; and the second thermal adhesive being coated in a glue shape on the clamping surface of the right clamping seat, allowing the outer surface of the memory to be affixed into the second thermal adhesive.

3. The memory cooling device according to claim 1, wherein the fixing interface of the left clamping seat is provided with connection holes, the fixing interface of the right clamping seat is provided with connection holes, and bolts are screwed into the connection holes to connect the left and right clamping seats into one body.

4. The memory cooling device according to claim 1, wherein heat generated from the bottom surface of the memory is transmitted to the clamping surface of the left clamping seat through the first thermal adhesive.

5. The memory cooling device according to claim 1, wherein the first heat pipe is provided with a second straight surface at a location opposite to the first straight surface, and the second straight surface is latched into and in touch with a groove wall of the groove.

6. The memory cooling device according to claim 1, wherein the first heat pipe is in a U shape and is provided with an outer pipe, with a surface of the outer pipe being latched with cooling fins.

7. The memory cooling device according to claim 1, wherein the left and right clamping seats are formed by aluminum extruding, and outer surfaces at sides are provided with cooling gills.

8. A memory cooling device comprising a left clamping seat which is provided with a lower clamping surface and a higher fixing interface, with the clamping surface being disposed with a continuous groove; a first heat pipe, at least one side of which is formed with a first straight surface, and which is latched into the groove, with a first thermal adhesive being affixed on the clamping surface and the first straight surface; a memory, a bottom surface of which is affixed on a surface of the first thermal adhesive; a second thermal adhesive which is affixed on an outer surface of the memory; a right clamping seat which is provided with a lower clamping surface and a higher fixing interface, with the clamping surface being disposed with a groove; and a second heat pipe, at least one side of which is formed with a first straight surface, and which is latched into the groove, with the second thermal adhesive being affixed on the clamping surface and the first straight surface; an outer surface of the memory being affixed on a surface of the second thermal adhesive, the fixing interface of the right clamping seat being connected and fixed with the fixing interface of the left clamping seat, and the left and right clamping seats clamping and fixing the memory and the first and second heat pipes, respectively; operating temperature generated by the memory being transmitted to the first thermal adhesive from the bottom surface, and then being directly transmitted to the first straight surface of the first heat pipe, whereas, the operating temperature generated by the memory being transmitted to the second thermal adhesive from the outer surface, and being directly transmitted to the first straight surface of the second heat pipe for cooling.

9. The memory cooling device according to claim 8, wherein the first thermal adhesive is coated in a glue shape on the clamping surface of the left clamping seat, and the first straight surface, allowing the bottom surface of the memory to be affixed into the first thermal adhesive, whereas the second thermal adhesive is coated in a glue shape on the clamping surface of the right clamping seat, allowing the outer surface of the memory to be affixed into the second thermal adhesive.

10. The memory cooling device according to claim 8, wherein the first and second heat pipes are provided with second straight surfaces at locations opposite to the first straight surfaces respectively, with the two second straight surfaces being latched into and in touch with groove walls of the two U-shape grooves, respectively.

11. The memory cooling device according to claim 8, wherein the fixing interface of the left clamping seat is provided with connection holes, the fixing interface of the right clamping seat is provided with connection holes, and bolts are screwed into the connection holes to connect the first and second clamping seats into one body.

12. The memory cooling device according to claim 8, wherein heat generated from the bottom surface of the memory is transmitted to the clamping surface of the left clamping seat through the first thermal adhesive, whereas heat generated from the outer surface of the memory is transmitted to the clamping surface of the right clamping seat through the second thermal adhesive.
